(19) United States
(12) Patent Application Publication
(10) Pub. No.: US 2013/0311213 A1
(43) Pub. Date: Nov. 21, 2013

(54) BAGGAGE HANDLING SYSTEM AND PROCESS FOR A TRANSPORT VEHICLE

(71) Applicant: Lorquon Holdings Pty Ltd., (US)

(72) Inventor: John W. SCHMIDT, North Albury (AU)

(73) Assignee: Lorquon Holdings Pty Ltd., North Albury (AU)

(21) Appl. No.: 13/874,818

(22) Filed: May 1, 2013

Related U.S. Application Data
(62) Division of application No. 12/520,351, filed on Dec. 15, 2009, now abandoned.

(30) Foreign Application Priority Data
Dec. 21, 2006 (AU) 2006907256

(51) Int. Cl. G06Q 10/02

(52) U.S. Cl. CPC G06Q 10/02
USPC 705/5

(57) ABSTRACT

A baggage handling process for a transport vehicle, including the steps of generating a booking for a passenger for said transport vehicle; and issuing the passenger with a container for his or her baggage, wherein the container is of a predetermined size and shape.

### TECHNICAL FIELD OF THE INVENTION

The present invention relates to a baggage handling process, system and computer program for a transport vehicle. The present invention also relates to a container for storing one or more travel items on a transport vehicle.

### BACKGROUND OF THE INVENTION

Airline companies, for example, typically transport passengers and their baggage to distant locations. Each passenger typically checks in one or two items of baggage. As such, an airline company is generally capable of:
1. Receiving baggage from the travellers;
2. Transferring baggage to aeroplanes; and
3. Packing the baggage inside aeroplanes.

Problems associated with executing these activities can be exacerbated when the baggage arrives in a myriad of different shapes and sizes.

A further difficulty encountered by airline companies, for example, occurs when a passenger decides not to board the aeroplane after he or she has checked in his or her luggage. The airline company is faced with the task of retrieving the passenger's baggage from the aeroplane. This process involves searching through the existing system inside the aeroplane for the passenger's baggage. The baggage may not be arranged in a manner which facilitates easy location of individual items. Flights are often delayed due to lengthy searches for baggage.

Airline companies and/or customs officials are sometimes faced with the task of searching through passenger's baggage for drugs, weapons, and other prohibited items. A difficulty with this task is that baggage comes in many different shapes, sizes, and styles. As such, each search may require time and patience to properly complete. This is particularly the case where bags include hidden pockets and false bottoms. It may be difficult for a customs official to efficiently and effectively search baggage.

It is generally desirable to overcome or ameliorate one or more difficulties of the prior art, or to at least provide a useful alternative.

### SUMMARY OF THE INVENTION

In accordance with one aspect of the invention there is provided, a baggage handling process for a transport vehicle, including the steps of:
(a) generating a booking for a passenger for said transport vehicle; and
(b) issuing the passenger with a container for his or her baggage,
   wherein the container is of a predetermined size and shape.

In accordance with another aspect of the invention there is provided, a baggage handling system for a transport vehicle, said system for performing the steps of:
(a) generating a booking for a passenger for said transport vehicle;
(b) generating an identifier for a container, the identifier being associated with the passenger;
(c) issuing the passenger with the container for his or her baggage;
   wherein the container is of a predetermined size and shape.

In accordance with another aspect of the invention there is provided, a computer program for handling baggage for a transport vehicle, said program for performing the steps of:
(a) generating a booking for a passenger for said transport vehicle;
(b) generating an identifier for a container, the identifier being associated with the passenger;
(c) issuing the passenger with the container for his or her baggage;
   wherein the container is of a predetermined size and shape.

In accordance with another aspect of the invention there is provided, a computer readable data storage medium, including stored thereon, the above described computer program.

In accordance with another aspect of the invention there is provided, a container for storing one or more travel items on a transport vehicle, including:
(a) a hollow receptacle having an aperture through which said travel items can received and stored in the container, and
(b) a locking device for inhibiting removal of the travel items from the hollow receptacle,
   wherein the container is of a predetermined size and shape.

In accordance with yet another aspect of the invention, there is provided an access port for a container, including:
(a) a container engaging member; and
(b) an access member,
   wherein the access member inhibits access to the contents of the container through an aperture in the container engaging member.

### BRIEF DESCRIPTION OF THE DRAWINGS

Preferred embodiments of the present invention are hereafter described, by way of non-limiting example only, with reference to the accompanying drawing in which:

FIG. 1 is a diagrammatic illustration of a baggage handling system connected to a network;

FIG. 2 is a diagrammatic illustration of a partially exploded perspective view of a container;

FIG. 3 is a diagrammatic illustration of a side view of the container shown in FIG. 1;

FIG. 4 is a diagrammatic illustration of a back view of the container shown in FIG. 1;

FIG. 5 is a diagrammatic illustration of a front view of the container shown in FIG. 1;

FIG. 6 is a diagrammatic illustration of a perspective view of the container shown in FIG. 1 arranged in another condition of use;

FIG. 7 is a diagrammatic illustration of a back view of the container shown in FIG. 6;

FIG. 8 is a diagrammatic illustration of a front view of the container shown in FIG. 6;

FIG. 9 is a front view of an access port of the container shown in FIG. 1;

FIG. 10 is a section view of the access port shown in FIG. 9 taken through the line A-A;

FIG. 11 is a front view of an access port of the container shown in FIG. 1 arranged in another condition of use;

FIG. 12 is a section view of the access port shown in FIG. 11 taken through the line B-B;

FIG. 13 is a side view of a container engaging member of the access port shown in FIG. 9;

FIG. 14 is a front view of the access port shown in FIG. 9 fitted with an inspection cap;

FIG. 15 is a side view of the access port shown in FIG. 14;

FIG. 16 is a section view of the access port shown in FIG. 14 taken through the line C-C;

FIG. 17 is a front perspective view of another container;

FIG. 18 is a back perspective view of the container shown in FIG. 17;

FIG. 19 is a bottom view of the container shown in FIG. 17;

FIG. 20 is a top view of the container shown in FIG. 17;

FIG. 21 is a side view of the container shown in FIG. 17;

FIG. 22 is a front view of the container shown in FIG. 17;

FIG. 23 is a back view of the container shown in FIG. 17;

FIG. 24 is a front perspective view of two of the containers shown in FIG. 17 stacked one on top of the other;

FIG. 25 is a back perspective view of the container shown in FIG. 17 arranged in another condition of use;

FIG. 26 is a diagrammatic illustration of the system shown in FIG. 1;

FIG. 27 is a flow chart showing the steps performed by the system shown in FIG. 1 to effect a booking for a passenger on a transport vehicle;

FIG. 28 is a flow diagram showing the steps performed by the system shown in FIG. 1 to check in a passenger on a transport vehicle;

FIG. 29 is a diagrammatic illustration of a racking system of the transport vehicle shown in FIG. 1; and

FIG. 30 is a flow diagram showing the steps performed by the system shown in FIG. 1 to locate a passenger's baggage in the racking system shown in FIG. 29.

### DETAILED DESCRIPTION OF PREFERRED EMBODIMENTS OF THE INVENTION

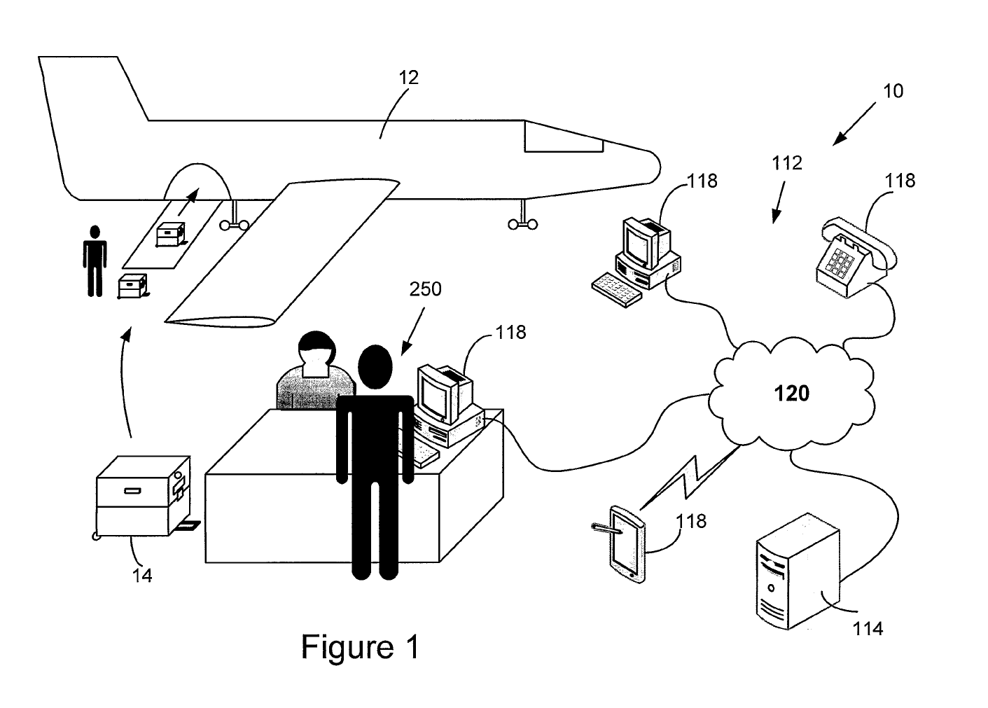

The baggage handling system 10 shown in FIG. 1 is used to improve baggage handling for transport vehicles 12. The system 10 is adapted to generate a booking for a passenger of the transport vehicle 12 and issue a container 14 to the passenger. The system 10 is also adapted to receive a container 14 from a passenger, including his or her baggage stored therein, and then store the container 14 in the transport vehicle 12. The containers 14 issued by the system 10 are of a predetermined size and shape for improved baggage handling.

The system 10 is hereafter described, by way of non-limiting example, with reference to a baggage handling system 10 for an aeroplane 12. However, the system 10 is suitable for use with any other transport vehicle 12, such a bus or a train, where difficulties are experienced with baggage handling.

### The Container

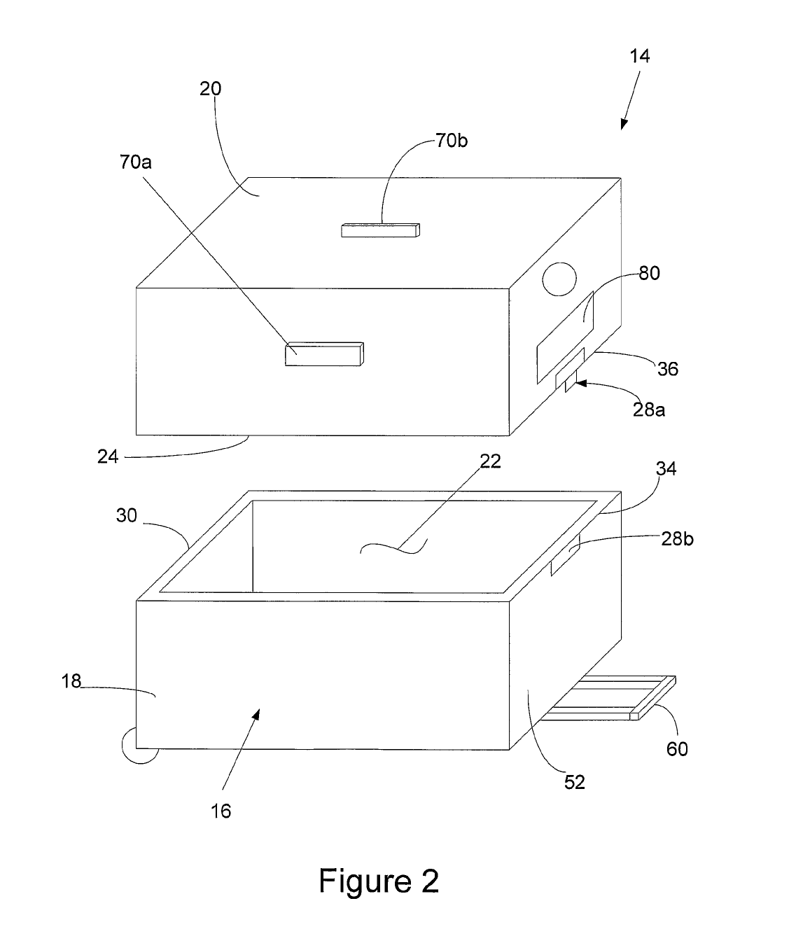

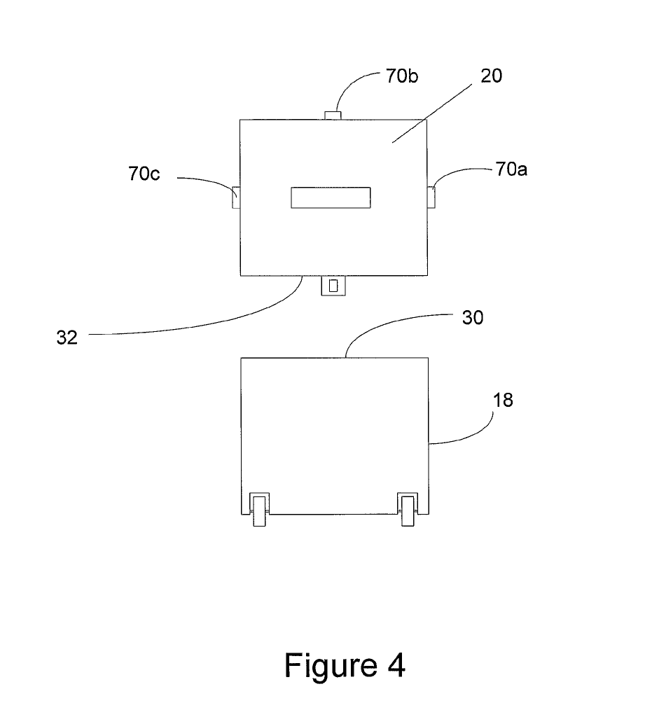

The container 14 shown in FIGS. 2 to 8 is used to store a passenger's travel items. The container 14 is of predetermined size and shape for ease of storing containers 14 in the aeroplane 12. The predetermined shape and size is uniform for all containers 14. The containers 14 are preferably issued by the system 10 in two different sizes.

The container 14 includes a housing 16 having a base 18 and a lid 20. The base 18 is a generally rectangular, hollow receptacle that is open at the top end 22 only. A passenger can place his or her travel items, such as clothing and toiletries, in the base 18 through the open top end 22. The lid 20 is also a generally rectangular, hollow receptacle that is open at the bottom end 24 only. The open bottom end 24 of the lid 20 is shaped for arrangement over the open top end 22 of the base 18. When so arranged, the contents of the container 14 are secured therein. The contents of the container 14 can be accessed by separating the lid 20 from the base 18. Lid section 20 is preferably of suitable size and shape to fit inside the base 18 for ease of dispatch. Alternatively, the lid 20 is generally planar and is shaped for arrangement over the open top end 22 of the base 18. When so arranged, the contents of the container 14 are secured therein.

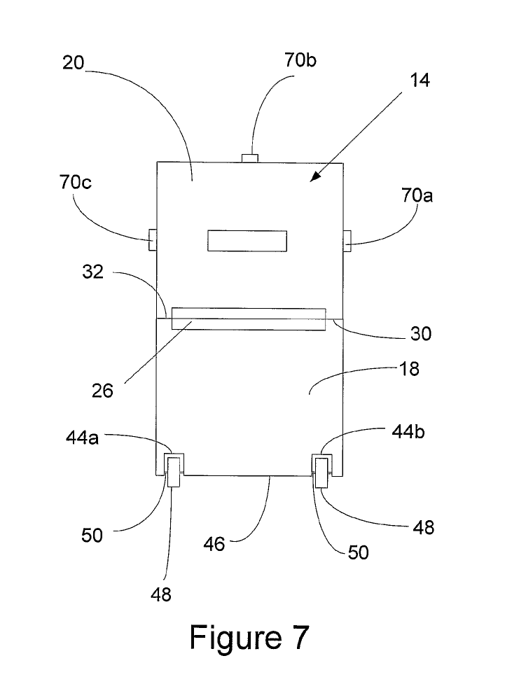

As particularly shown in FIG. 7, the lid 20 is fastened to the base 18 by way of a hinge 26. The hinge 26 extends at least partially across corresponding back edges 30, 32 of the base 18 and the lid 20. The lid 20 can rotate about an axis defined by the hinge 26 towards the base 18 to move towards a closed condition of use. Similarly, the lid 20 can rotate about the axis defined by the hinge 26 away from the base 18 to move towards an open condition of use. The container 14 can thereby by opened and closed.

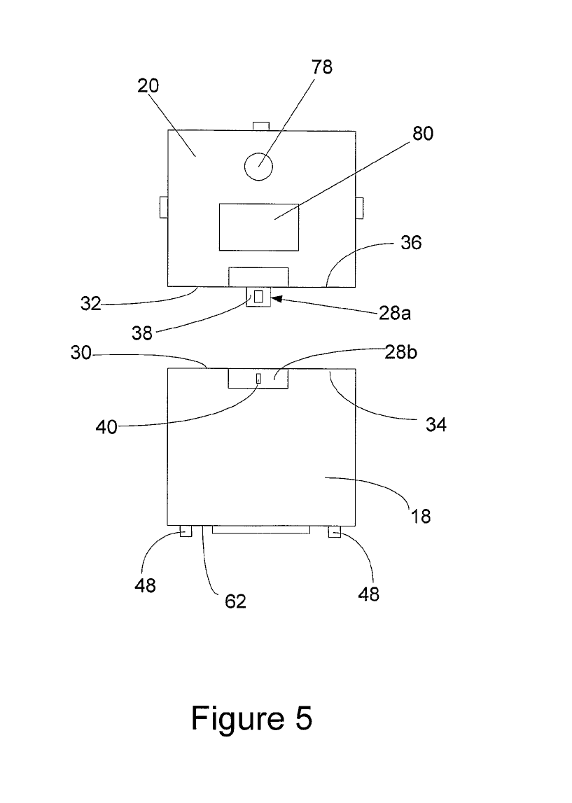

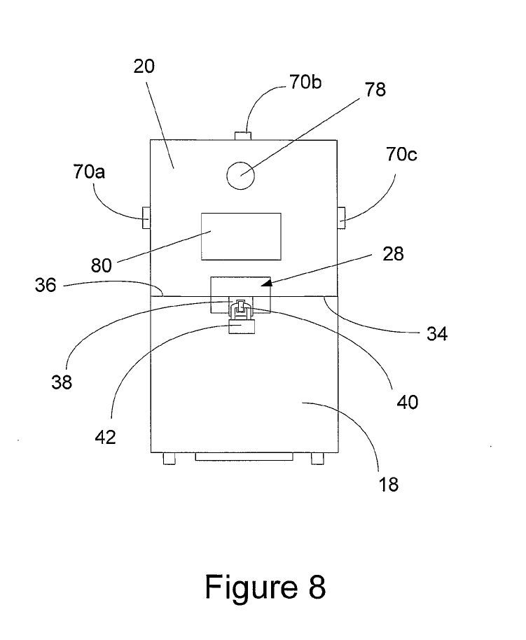

The container 14 is secured in the closed condition of use by the fastener 28 shown in FIGS. 5 and 8. The fastener is preferably a lock 28 that prevents the front edge 34 of the open end 22 of the base 18 from being separated from the open front end 36 of the bottom of the lid 20. The travel items stored in the container 14 can be accessed if the lock 28 is released from the container 14 and the lid 20 moves towards an open condition of use.

As particularly shown in FIG. 5, the lock 28 includes top and bottom parts 28a, 28b. The top part 28a of the lock 28 is coupled to the front edge 36 of the open end 24 of the lid 20. The top part 28a includes a flange 38 extending downwardly there from. The flange 38 overlies the bottom part 28b of the lock 28 when the container 14 is arranged in a closed condition of use. The bottom part 28b of the lock 28 includes a loop 40 that projects outwardly from the front side of the container 14. The loop 40 is arranged such that it at least partially extends through an aperture in the flange 38 when the container 14 is arranged in the closed condition of use. When so arranged, a combination lock 42 can be employed to extend through the loop 40 and fasten the flange 38 between the combination lock 42 and the bottom part 28b of the lock 28. The container 14 is locked when the combination lock 42 is arranged in the described manner. The combination lock 42 is alternatively a pad lock or any other suitable locking device. Alternatively, the fastener can be any other suitable means for securely coupling the lid 20 to the base 18.

The contents of the container 14 can be accessed by opening the lock 28. Alternatively, the contents of the container 14 can be advantageously accessed by breaking the hinge 26. The hinge 26 is preferably adapted to be dismantled so that the lid 20 can be separated from the base 18 to allow access to the items secured therein. The hinge 26 is permanently deformed during this process and cannot be used to again close the container 14. Alternatively, the hinge 26 can be repaired in a tamper evident way after it has been dismantled.

As particularly shown in FIG. 7, the container 14 includes left and right wheel arches 44a, 44b set into the back edge 46 of the closed end of the base 18. The container 14 includes wheels 48 coupled to and seated in corresponding wheel arches 44a, 44b by axles 50. The wheels 48 are recessed sufficiently into the back edge 46 of the container 46 so that they engage a floor or ground surface when the base 18 of the container 14 is sits flat on the floor or ground surface. The wheels 48 also engage the floor or ground surface when the passenger picks up the front 52 end of the container 14 and raises the front end upwards towards a vertical position.

The wheels 48 include a scale system that indicates the weight of the container and its contents. In this embodiment, the axles 50 are coupled to the arches 44a, 44b by rigid springs (not shown) in such a way that the weight of the container forces the axles 50 to resiliently retract into the wheel arches 44a, 44b when the centre of weight of the container 14 is aligned generally vertically over the axles 50. An exterior section of the container includes a indicia (not shown) the represents a scale showing how far the axles 50 have retracted into the arches 44a, 44b when the container is arranged in the described manner. The markings are calibrated to represent the weight of the container. A person can thereby simply determine the weight of the container by rotating it about its axles 50 to an angle of 45 degrees to the horizontal, for example, and reading the scale.

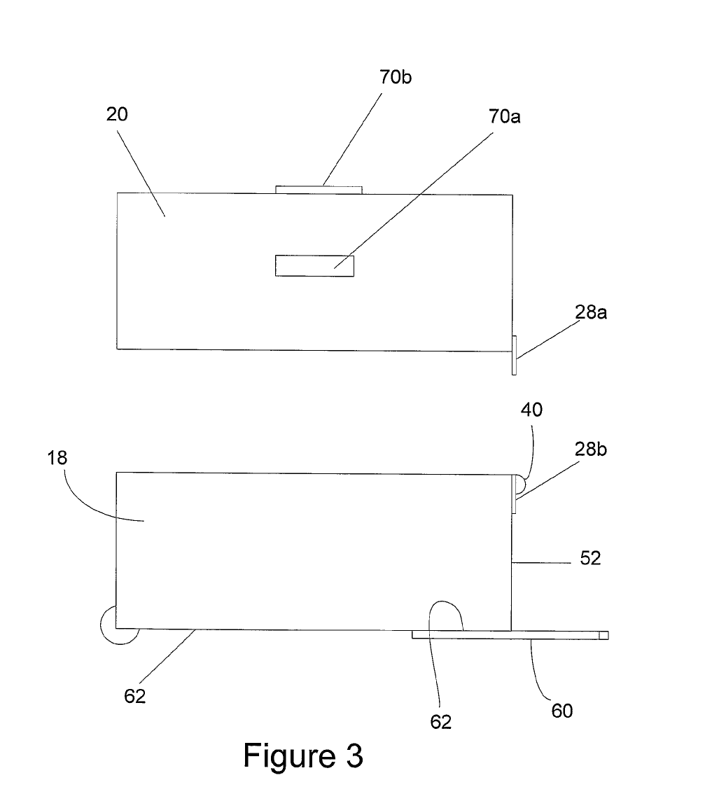

As particularly shown in FIG. 3, the container 14 includes handle 60. The handle 60 is coupled to an outer peripheral section 62 of the closed end of the base 18 and extends outwardly from the front end 52 of the container 14. The handle 60 is preferably adjustable in length. That is, the distance that the handle 60 extends outwardly away from the front end 52 of the container 14 can be extended.

The handle 60 is preferably fastened to the outer peripheral section 62 of the closed end of the base 18 by a plurality of fasteners (not shown). The handle 60 is easily removable so as to inhibit theft. The containers 14 are preferably made with different stud patterns for the fasteners of the handles to avoid handle swapping. The handle 60 includes a clear plastic container for carrying documents on to the aircraft.

As particularly shown in FIGS. 7 and 8, the lid 20 includes lugs 70a, 70b, 70c coupled to, and project outwardly from, the left side 72, the top 74 and the right side 76. The lugs 70a, 70b, 70c assist in lifting the containers 14 into the racking system of an aeroplane 12, for example. The lugs 70a, 70b, 70c preferably accept mechanical, magnetic, Velcro™ or suction lifting system.

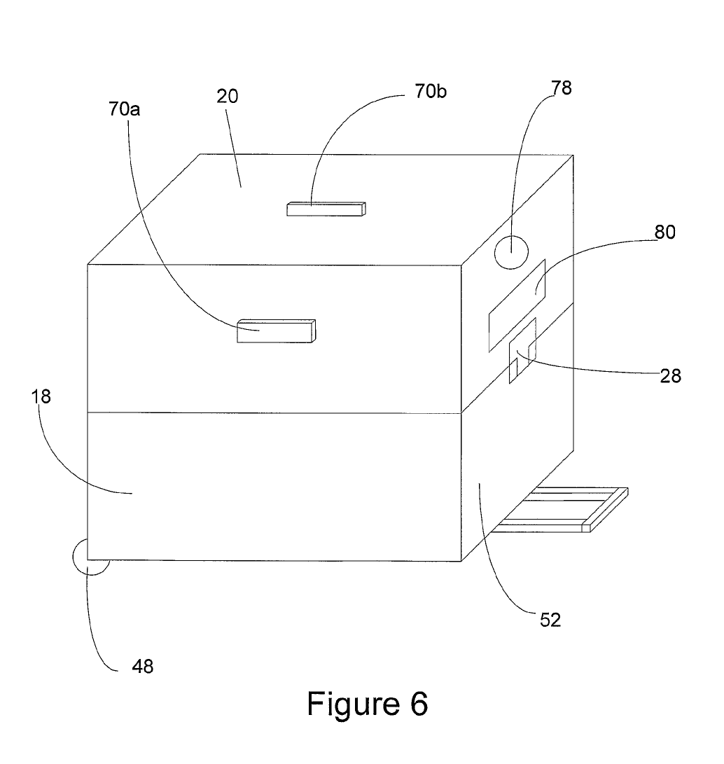

As particularly shown in FIG. 6, the container 14 includes an access port 78 that permits gasses, liquids, and/or audio visual apparatus, for example, to enter and/or exit the container 14. Suspect contents of the container 14 can thereby be sampled or inspected without it being properly opened. Similarly, if the contents of the container is considered dangerous, then a neutralising agent can be pumped into the container through the port 78. For example, testing the air inside the container through the port 78 may confirm the presence of dangerous explosives or chemicals. Similarly, sampled air from inside the container 14 could indicate the presence of animal or plant material. The audio visual equipment permits the contents of the container 14 to be visually and audibly inspected from a position remote from the container.

The access port 78 is not limited for use with the container 14. Rather, the access port 78 is suitable for use with any other form of container whose contents may need to be inspected. Shipping containers, for example, may include multiple access ports 78 so that different areas within the container can be accessed. The access port 78 is hereafter described, by way of non-limiting example, by way of reference to the container 14.

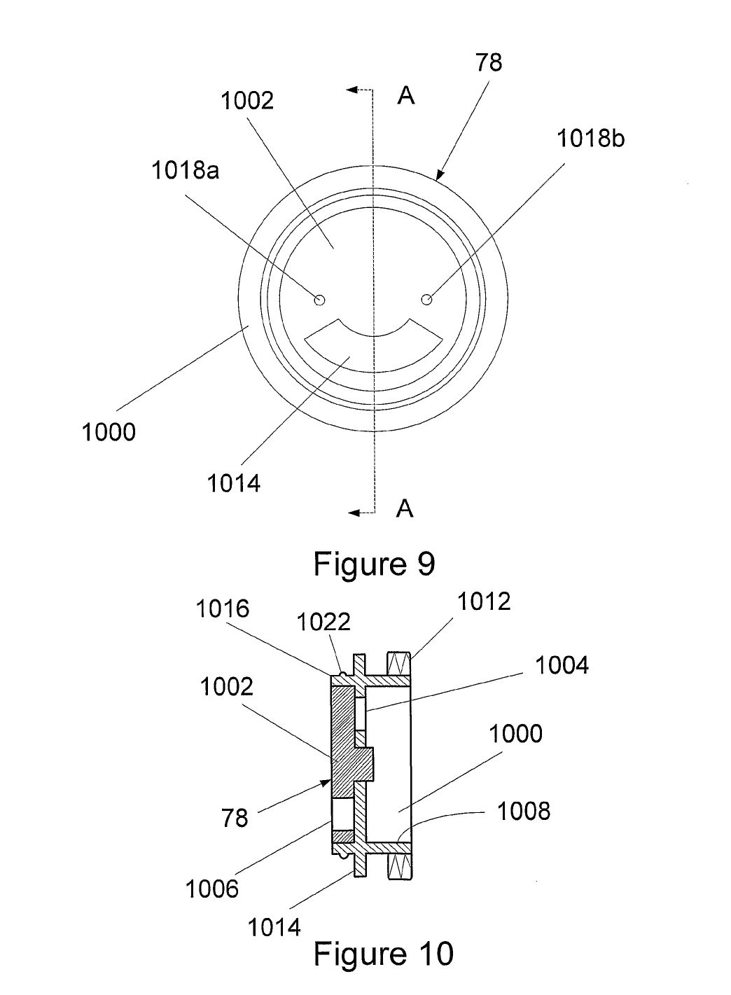

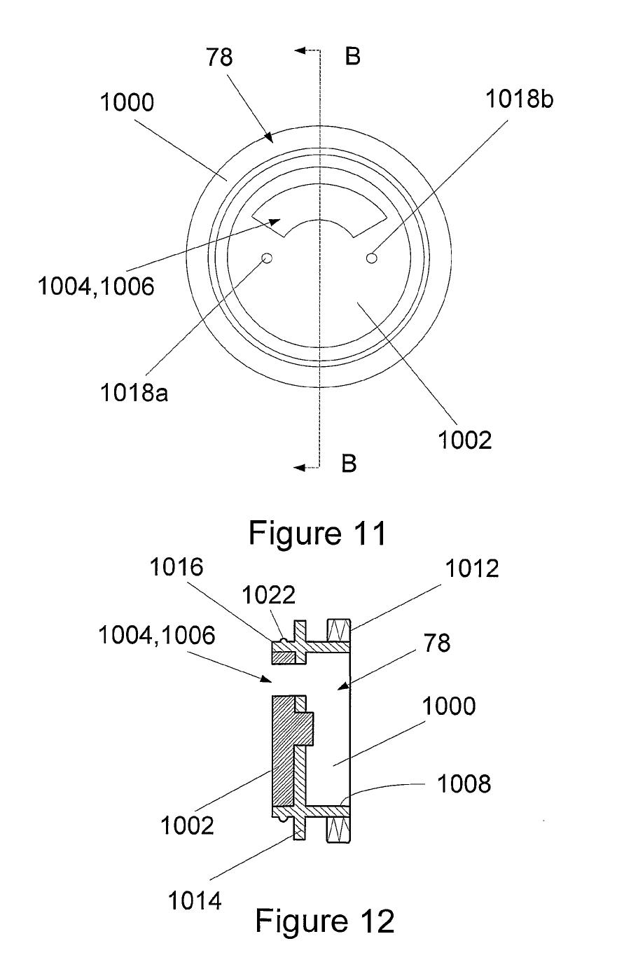

An exemplary embodiment of the access port 78 is shown in further detail in FIGS. 9 and 10. The access port includes a container engaging member 1000 coupled to an access member 1002. The access member 1002 is movable with respect to the container engaging member 1000 so as to open and close an aperture 1004 defined by the container engaging member 1000. The access member 1002 can thereby be used to control access to the contents of the container 14. When arranged in the closed condition of use shown in FIGS. 9 and 10, the access member 1002 inhibits access to the contents of the container. The access member 1002 preferably has a sealing engagement with the container engaging member 1000 and thereby inhibits ingress and egress of gasses and liquids into and out of the container. When arranged in the open condition of use shown in FIGS. 11 and 12, an aperture 1006 defined by the access member 1002 permits access to the contents of the container 14. The access member 1002 is preferably pivotably coupled to the container engaging member 1000 so that the access member 1002 can be turned to align the apertures 1004, 1006 or to inhibit access to the aperture 1004.

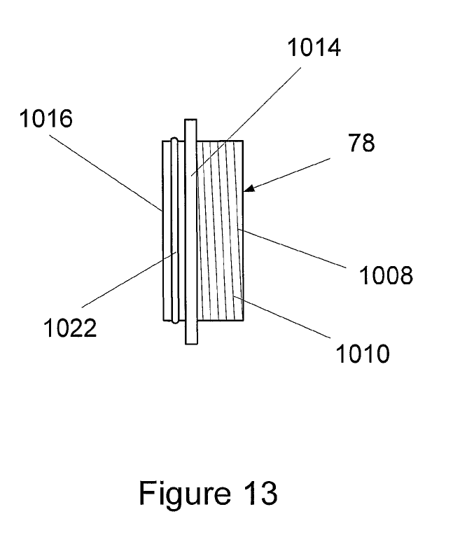

As particularly shown in FIG. 13, the container engaging member 1000 includes a hollow cylindrical fastening section 1008 that has an outer peripheral screw thread 1010 shaped for engagement with a corresponding female screw thread of a fastener 1012 fitted to a wall of the container 14. The container engaging member 1000 can thereby secured to the container 14 by screwing the fastening section 1008 into the fastener 1012. The container engaging member 1000, alternatively, is coupled to the side of the container 14 by any other suitable means.

An end of the fastening section 1008 is partially closed by an interface member 1014. The interface member 1014 is a generally planar circular member whose radius is greater than that of the hollow cylindrical fastening section 1008. The interface member 1014 thus extends beyond the width of the fastening section 1008 and functions as a locking surface for the screw thread 1010 as the container engaging member 1000 is being screwed into the fastener 1012.

The container engaging member 1000 includes an outer hollow cylindrical member 1016 coupled to and extending away from another side of the interface member 1014. The outer cylindrical member 1016 is arranged coaxially with, and has the same general diameter as, the fastening section 1008. The access member 1002 is seated in a recess defined between the outer cylindrical member 1016 and the interface member 1014. The access member 1002 is coupled to the interface member 1014 in a manner that facilitates rotation of the access member 1002 with respect to the container engaging member 1000. The access member 1002 can thereby turned with respect to the interface member 1014 to align or close the apertures 1006, 1004 formed in the access member 1002 and the interface member 1014 respectively.

The access member 1002 preferably includes locking pins 1018a, 1018b to securely retain the access member 10002 in either the closed condition of use shown in FIG. 9 or the open condition of use shown in FIG. 10.

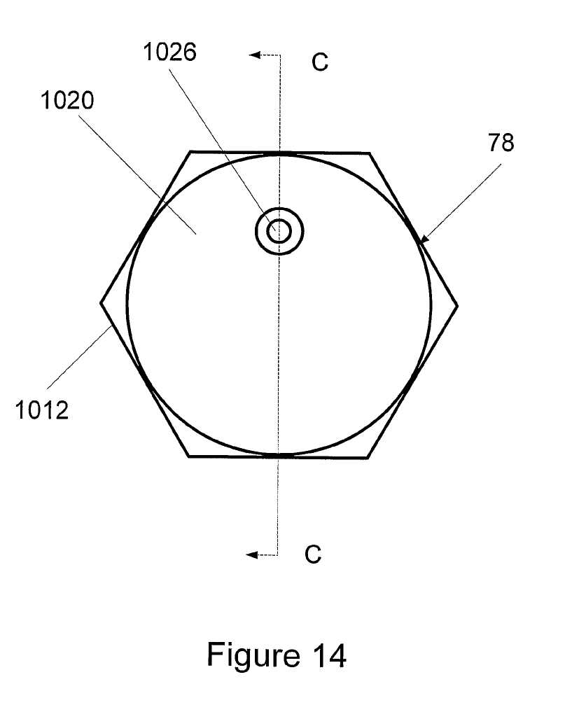

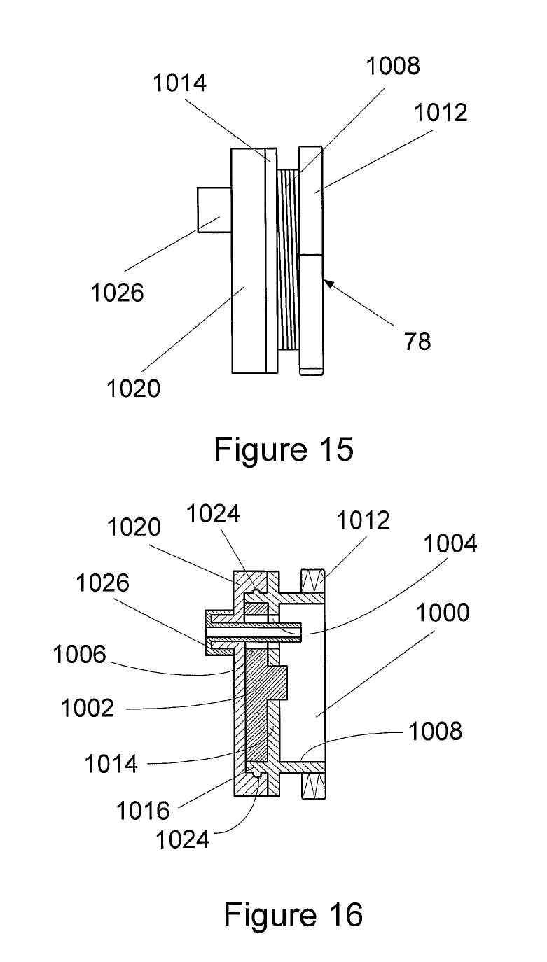

The access port 78 can be used in the above described manner to gain access to the container 14. However, accessing the container 14 in this manner may adversely affect the integrity of the contents of the container 14. That is, opening the aperture 1004 and permitting inspection of the container 14 may introduce contaminants into the container 14. The contents of the container 14 can be inspected with for forensic analysis by way of the inspection cap 1020 shown in FIGS. 14 to 16. The inspection cap 1020 permits inspection of the contents of the container 14 without adversely affecting the integrity of any samples taken therefrom.

The cap 1020 is generally cylindrical and shaped to fit over and couple to the outer cylindrical member 1016 of the container engaging member 1000. The parts 1016, 1020 are couple together by way of resilient engagement between a raised protrusion 1022 that extends around an outer peripheral surface of the outer cylindrical member 1016, and a corresponding recess 1024 that extends around an inner peripheral surface of the cap 1020. The cap 1020 can thereby be fitted to the container engaging member 1000. In this embodiment, the access member 1002 fills the recess defined by the outer cylindrical member 1016 and an inner surface of the cap 1020 abuts an outer surface of the access member 1002. In this arrangement, there is substantially no air gap between the cap 1020 and the plate 1002.

The cap 1020 also includes a hollow elongate cylindrical probe 1026 that is shaped to extend from an outer peripheral surface of the cap 1020 through the apertures 1006, 1004 in the access member 1002 and the interface member 1014 and into the container 14. The probe 1026 is preferably closed at both ends. In one arrangement, the access port 78 can be used by turning the access member 1002 so that the apertures 1004, 1006 are aligned and then fitting the cap 1020 over the container engaging member 1000. In doing so, the probe 1026 is arranged to extend into the container 14. A person can gain access to the container 14 by piercing through the closed ends of the probe 1026.

In an alternative embodiment, the probe 1026 is shaped to extend from the outer peripheral surface of the cap 1026 into the aperture 1006 only. The probe 1026 is thereby seated in the aperture 1006. In this embodiment, the cap 1020 is fitted to the container engaging member 1000 when the access member 1002 is arranged in the closed condition of use and the cap 1020 is turned so that it rotates through 180 degrees. In doing so, the cap 1020 engages the access member 1002 and also rotates it through 180 degrees. The result is that the apertures 1004 and 1006 are aligned and that the probe 1026 is arranged adjacent the aperture 1004. A person can gain access to the container 14 by piercing through the closed ends of the probe 1026. By following these steps, contaminants are prevented from entering the container 14. The probe 1026 preferably forms part of apparatus for sampling the contents of the container or for inserting liquids or gasses into the container. Preferably, the pins 1018a, 1018b access member 1002 must first be engaged before the access member can rotate to the open position.

In another alternative arrangement, the aperture 1004 defined in the interface plate 1014 is closed by a membrane (not shown). The membrane is made of any suitable material that inhibits ingress and egress of liquids and gasses into and out of the container. The access port 78 can be used by turning the access member 1002 so that the apertures 1004, 1006 are aligned and then fitting the cap 1020 over the container engaging member 1000. In doing so, the probe 1026 is arranged to extend into the container 14 and does so by piercing through the membrane. A person can then gain access to the container 14 by piercing through the closed ends of the probe 1026. The contents of the container are thereby not contaminated by opening the port 78.

Advantageously, the membrane is made of a material that permits access to the container when immersed in water, for example. In this embodiment, if the container falls off a ship, for example, then the membrane will dissolve in the salt water and open the access ports 78 thereby flooding and sinking the container 14.

The container 14 preferably includes a Global Positioning System locator electronic circuit. The locator circuit is preferably built into the container 14 at the time of its construction.

As particularly shown in FIG. 6, the container 14 includes a primary label 80 located on the front 52 of the container 14. The primary label 80 bears the surname of the owner of the container 14 and a container 14 identifier, for example. The container 14 includes a secondary label (not shown) inside the lid 20 of the container 14. The secondary label bears the full name, address and contact details of the owner of the container 14 and the container 14 identifier, for example. The identifier is preferably a bar code that uniquely identifies the container 14.

The container 14 is preferably constructed of a single or laminated high strength skin, moulded by machine. The container 14 preferably includes no voids or spaces in the walls. The housing 16 of the container 14 is preferably includes chemical and/or acid resistant materials. The housing 16 preferably includes electrically conductive materials that form a Faraday cage when the base 18 and the lid 20 are closed together. The housing is therefore an enclosure constructed of grounded wire mesh or parallel wires that shields electrical instruments inside the container from electrostatic interference.

All container 14 components preferably have a part number. These details are preferably stored on the system 10.

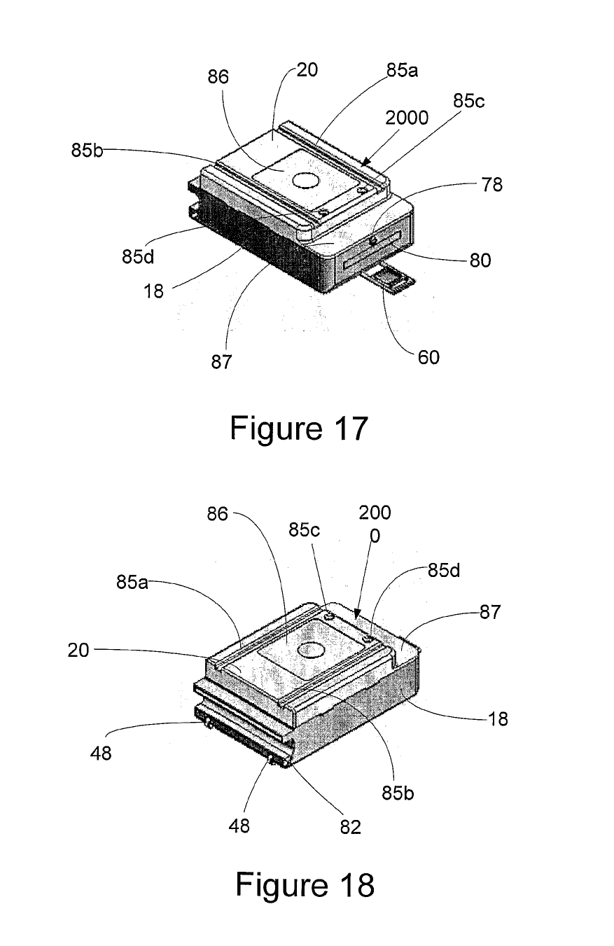

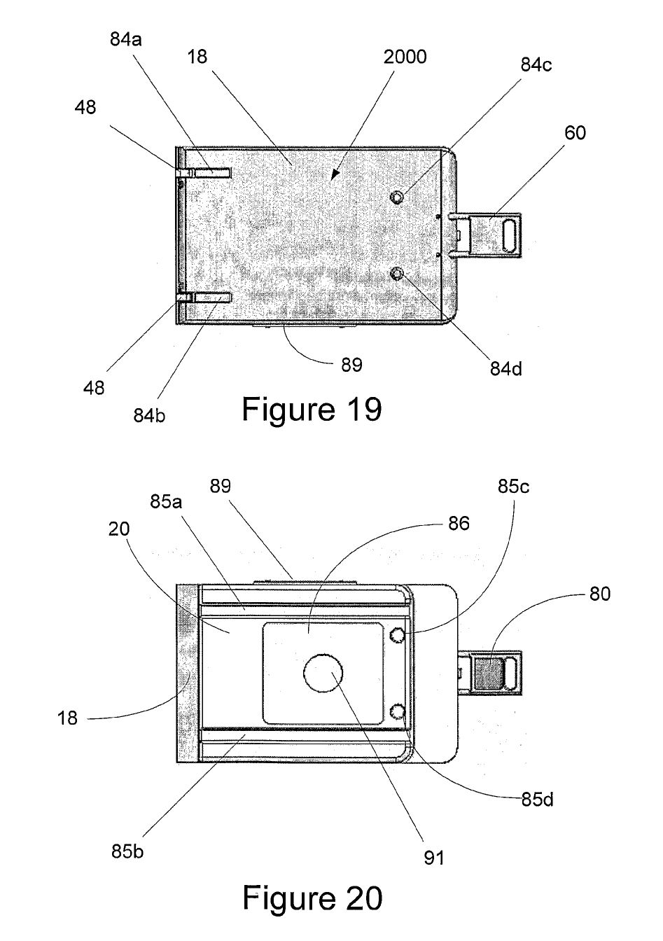

An alternative embodiment of the container 2000 is shown in FIGS. 17 to 23. The container 2000 functions in an analogous manner to that of the container 14 and includes many of the same features. As such, common parts have been identified with common reference numerals. These parts have been above-described in detail. Their descriptions are equally applicable for the container 2000.

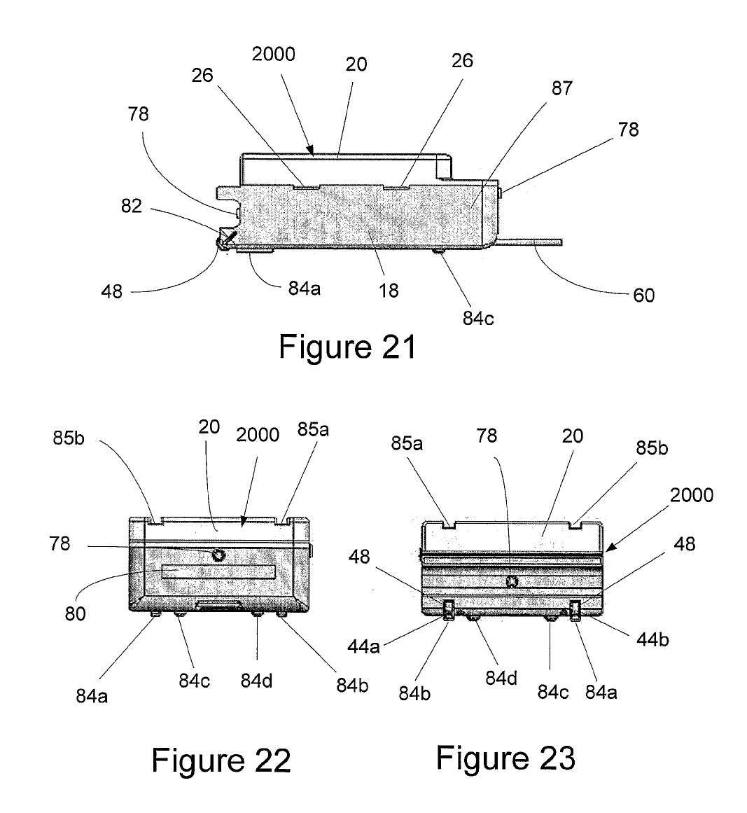

As particularly shown in FIG. 21, the wheels 48 include a scale system 82 that indicates the weight of the container and its contents. In this embodiment, the axles 50 are coupled to the arches 44a, 44b by rigid springs (not shown) in such a way that the weight of the container forces the axles 50 to resiliently retract into the wheel arches 44a, 44b when the centre of weight of the container 14 is aligned generally vertically over the axles 50. An exterior section of the container 14 includes indicia the represents a scale showing how far the axles 50 have retracted into the arches 44a, 44b when the container 14 is arranged in the described manner. The markings are calibrated to represent the weight of the container 14. A person can thereby simply determine the weight of the container 14 by rotating it about its axles 50 to an angle of 45 degrees to the horizontal, for example, and reading the scale.

For the container 2000, the hinge 26 is located on corresponding side sections of the base 18 and lid 20. The hinge 26 is preferably tamper proof or tamper evident. The lid 20 is adapted to rotate about the hinge 26 in the above-described manner. The lid 20 is securely coupled to the base 18 by way of a fastener 89. The fastener 89 preferably includes latches 89 with combination locks or biometric locks, for example.

A bottom side of the base 18 includes lugs 84a, 84b, 84c, 84d for mating with corresponding recesses 85a, 85b, 85c, 85d of an upper side of the lid 20. The lugs 84a, 84b, 84c, 84d and corresponding recesses 85a, 85b, 85c, 85d assist in improving the stability of stacked containers 2000. Two of the recesses 85a, 85b are preferably are preferably elongate parallel channels that extend between front and back ends of the lid 20. Corresponding lugs 84a, 84b and/or wheels can thereby slide along the channels 85a, 85b.

The recesses 85a, 85b there by accommodate the wheels to slide there along and assist in stacking of the containers 14. The other two recesses 85c, 85d preferably mate with corresponding lugs 84c, 84d and inhibit movement of the containers 2000 with respect to each other.

The container 2000 include two access ports 78 located in the front and rear sides. The access ports 78 are above-described in detail with reference to FIGS. 9 to 16. The ports 78 provide improved access to the contents of the container 2000.

The container 2000 includes one or more predetermined areas 86 for receiving advertisements.

The area inside the container 2000 is divided between a front end section 87 that is of suitable dimensions to receive hand luggage and a back end section 88 that is of suitable size and shape to receive normal travelling items, such as clothing.

The container 2000 also includes an expansion membrane 90 to compensate for small explosions.

The container 2000 also includes a suction lifting plate 91 that enables the container 2000 to be safely lifted and moved under the influence of a suction pump.

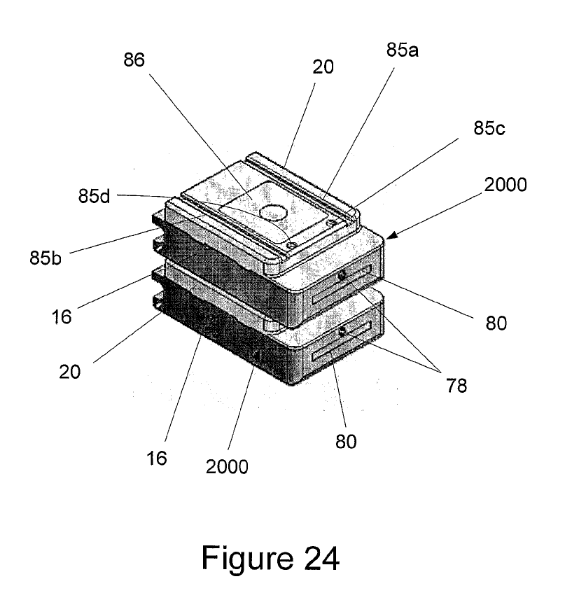

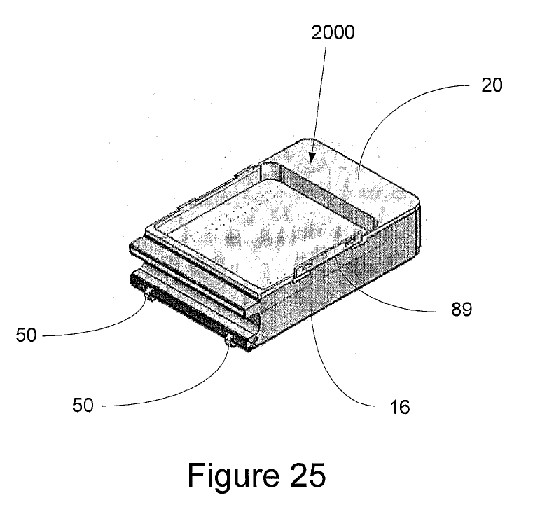

The lid 20 of the container 2000 is adapted to be used in the arrangement shown in FIGS. 17 to 24. However, it is also adapted to be used in the arrangement shown in FIG. 25 where it is upside down to its previous configuration. The lid 20 sits largely flat with the top of the base 18 and therefore improves its ability to be transported.

### The Computer System

The baggage handling system 10 is provided by the computer system 112 which can be used by an airline company, for example, to facilitate a number of functions, including:

### 1. Booking Tickets;

### 2. Issuance of Containers;

### 3. Checking in Baggage; and

### 4. Tracking of Baggage.

The computer system 112 includes a server 114 which is able to communicate with equipment 118 of members of the system 112 over a communications network 120 using standard communication protocols. Members of the system include authorised airline staff members and past, current, and future passengers of the aeroplane. The equipment 118 of the members can be a variety of communications devices 118 such as personal computers; interactive televisions; hand held computers etc. The communications network 120 may include the Internet, telecommunications networks and/or local area networks.

The components of the computer system 112 can be configured in a variety of ways. For example, the components can be implemented entirely by software to be executed on standard computer server hardware, which may comprise one hardware unit or different computer hardware units distributed over various locations, some of which may require the communications network 120 for communication. A number of the components or parts thereof may also be implemented by application specific integrated circuits (ASICs). It will be apparent from the description of the system 112, and its operation below, that the most practical implementation of the components of the computer system 112 is a software implementation. Alternative methods of providing system displays and information can also be used, for example WML pages for mobile telephones, and interactive voice response (IVR) systems for connection to standard fixed telephones or voice over IP terminals.

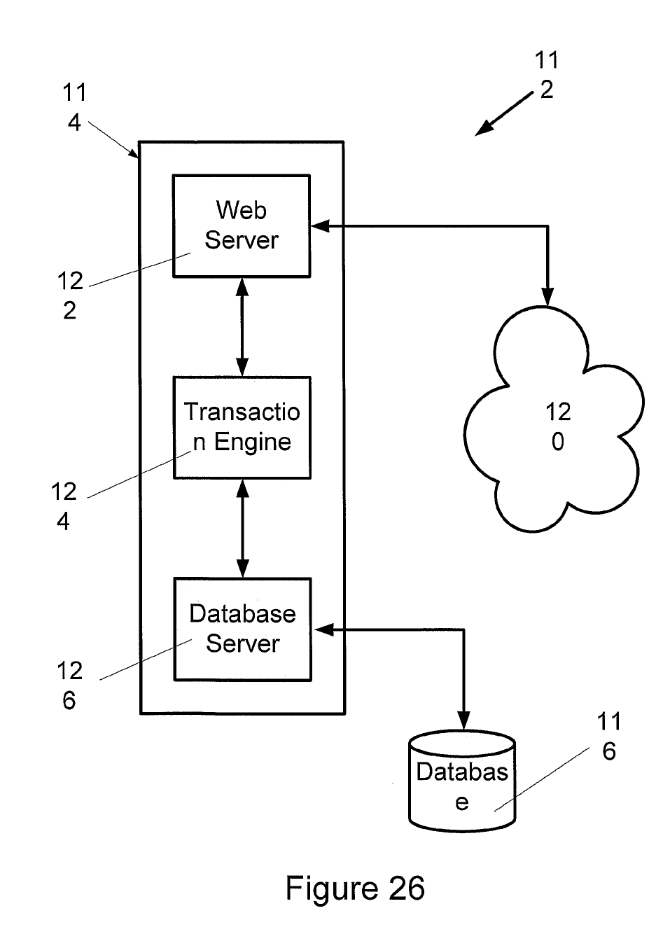

The server 114 includes a web server 122, a transaction engine 124 and a database server 126 arranged in the manner shown in FIG. 26. The web server 122 is software stored on the server 114 that allows the computer system 112 to serve static and dynamic web pages of the web application. The web server 122 allows members of the system 112 to access web pages created and stored on the computer system 112 via their respective communications devices 118. The web pages published by the web server 122 are dynamic and are populated by data provided by the transaction engine 124 of the computer system 112.

The transaction engine 124 is software that processes data received by the web server 122 from users of the system 112 via their terminals 118 and is able to retrieve and store data on the database 116 via the database server 126. The transaction engine 124 communicates with the web server 122 and database server 126 to execute data transactions for the system 112 and thereby provides dynamic content for the web pages provided by the web server 122, as described below.

The database server 126 is software stored on the server 114. The database server 126 reads, writes, maintains and secures data on the database 116. The database server 126 maintains data in the database 116 for all members of the system 112. The database 116 is maintained preferably on hard disk storage of the server 114 of the computer system 112.

As above mentioned, the baggage handling system 10 can be used by an airline company, for example, to facilitate a number of functions, including:

### 1. Booking Tickets;

### 2. Issuance of Containers;

### 3. Checking in of Baggage; and

### 4. Tracking of Baggage.

Each one of these functions is described in further detail below:

### 1. Booking Tickets

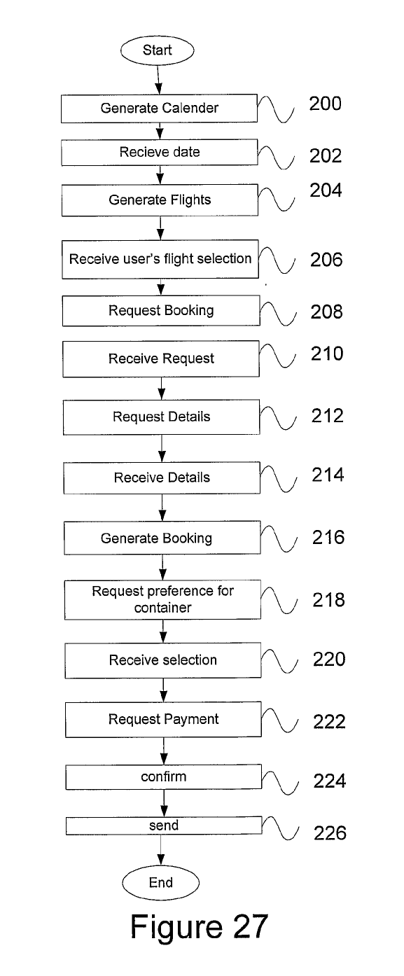

The passenger can use his or her personal computer 118 to access the airline's web site, via the Internet 120, to book a ticket to travel on an aeroplane 12. The system 112 performs the steps shown in FIG. 27 to book a ticket on an aeroplane for a passenger. These steps are described in further detail below.

The airline company's web page (not shown) includes a “Book Ticket” function button that, when executed, generates, at step 200, a calendar showing a range of flight dates that can be selected by the passenger. The system 112 receives the passenger's preferred flight date, at step 202, and then generates, at step 204, the flights available for the date selected. The passenger can view of the flights available on the date selected and choose a preferred flight time. The system 112 receives, at step 206, the passenger's preferred flight details and then requests, at step 208, the passenger to book the flight. On receipt of the passenger's confirmation to book the flight, at step 210, the system 112 requests, at step 212, the following contact information from the passenger:
i. Surname;
ii. Given names;
iii. Postal address;
iv. Telephone number; and
v. E-mail address.

On receipt of the above details from the passenger, at step 214, the system 112 generates, at step 216, a booking including the following information:
i. Passenger contact information;
ii. Flight details;
iii. Booking number;
iv. Identifier;
vi. Container delivery method;
vii. Method of issuance of container.

The booking number and Identifier are generated for the passenger by the system 112 when the booking is generated. The identifier is preferably a bar code number which can be later printed out and fastened to the passenger's container 14.

The system 112 then requests, at step 218, the passenger to select an option to either pick up a container 14 from the airline company in person, or for the system 112 to send a container 14 to his or her postal address. The system 112 receives the passenger's selection, at step 220, and then stores, at step 218, the booking, and associated data, on the database 116.

The system 112 then requests, at step 222, payment for the booking. The passenger can effect payment by submitting his or her credit card details. This process is known in the art and is not described here in further detail.

On receipt of confirmation of payment from the passenger, the system 112 concludes the booking process by generating a confirmation message, at step 224, for display on the passenger's computer 118. The confirmation message includes booking details. If the passenger elects to have the container 14 sent to them, then the system 112 sends, at step 226, a request to an appointed staff member of the airline to send the passenger a container 14.

The above described steps performed by the system 112 to book a ticket on the aeroplane 12 can be performed by an authorised staff member of the relevant airline company if the passenger calls the airline company by telephone 118 or the passenger makes a booking in person at the offices 250 of the airline company.

### 2. Issuance of Containers

When the system 112 issues, at step 226, a container 14 to a passenger, the container 14 includes the identifier and the passenger's surname on the primary identifier label 80. Further, the container includes the identifier and the passenger's contact information on the secondary identifier label. The container 14 is similarly marked when the container 14 is picked up by the passenger.

### 3. Checking in of Baggage

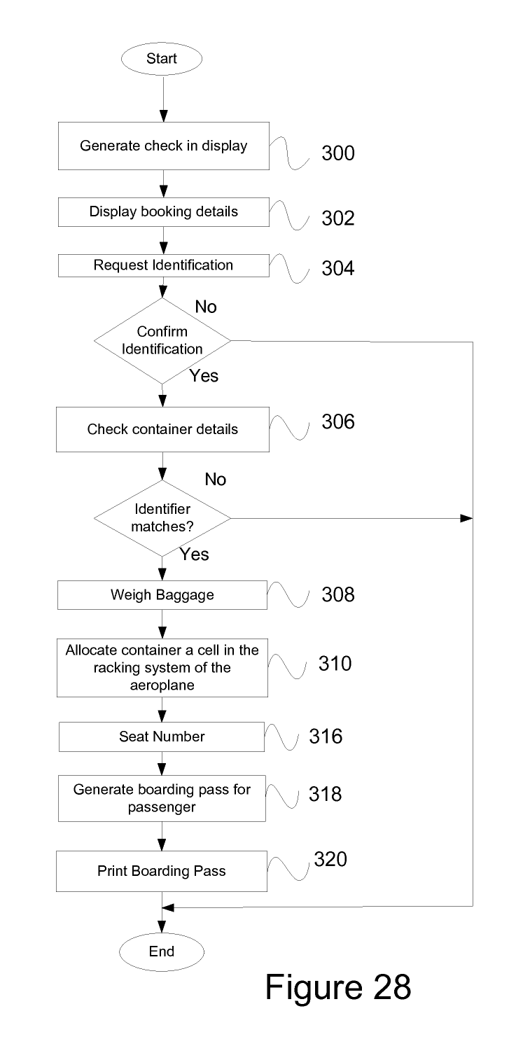

A passenger packs all of his or her travel items in the container 14 and then closes the container 14. The container 14 is locked closed using the combination lock 42. To check in to a flight, the passenger presents himself or herself at the “Check In” counter 250 at the relevant airport. An authorised staff member uses his or her computer terminal 118 to check the passenger in and generate a boarding pass. The steps performed by the system 112 to check the passenger in and generate the boarding pass are shown in FIG. 28 and are described in further detail below.

The staff member can use his or her computer 118 to access the airline's web page, via the Internet 120, to check in the passenger. The system 112 web page includes a “Check In” function button that, when executed, generates, at step 300, a check in display including a text box requesting entry of the passenger's name or booking number. On receipt of either one of these details, the system 112 generates, at step 302, a display showing the passenger's booking details. The staff member requests the passenger to produce suitable identification and confirms that the passenger is the right person.

The staff member then checks, at step 306, the container's details. For example, the staff member checks the primary identifier label 80 on the container 14 and confirms that the surname listed matches the surname of the passenger. The staff member then checks that identifier on the container 14 matches the identifier stored in the booking information on the system 112. The identifier is preferably read into the system 112 by a bar code reader.

The passenger opens the container in the presence of the staff member and takes their hand luggage and places it in the area designated to receive it. The passenger then removes the handle 60 to take on board the aircraft.

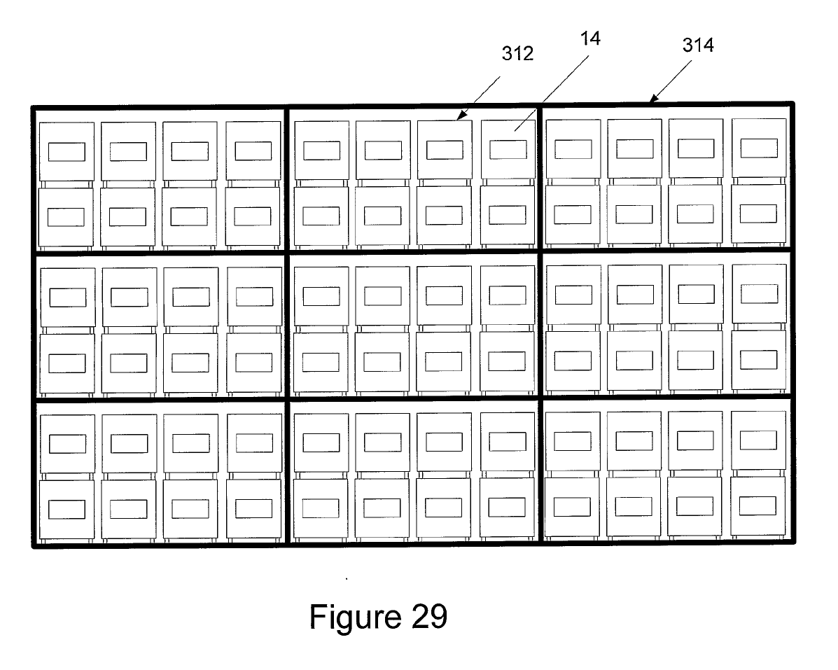

Once the staff member has checked that the details on the primary identifier label 80 match the booking information on the system 112 for the passenger, he or she weighs the container 14 and enters the weight, at step 308, into the system 112. The system 112 then allocates, at step 310, the container 14 a cell 312 in the racking system 314 of the aeroplane 12 shown in FIG. 29. The system 112 then generates, at step 316, a seat number for the passenger for the flight.

The system 112 then generates a boarding pass for the passenger which includes the following information:
i. Passenger contact information;
ii. Flight details;
iii. Booking number;
iv. Identifier;
v. Weight of container;
vi. Cell number in racking system;
vii. Seat number; and
viii. Gate number.

Finally, the system 112 prints, at step 320, a copy of the boarding pass for the passenger that includes the following information:
i. Passenger Name;
ii. Flight details;
iii. Seat number; and
iv. Gate number.

The staff member ensures that the container 14 is locked and sends the container to the appropriate cell 312 of the racking system 314 in the aeroplane 12, as shown in FIG. 29.

### 4. Tracking of Baggage

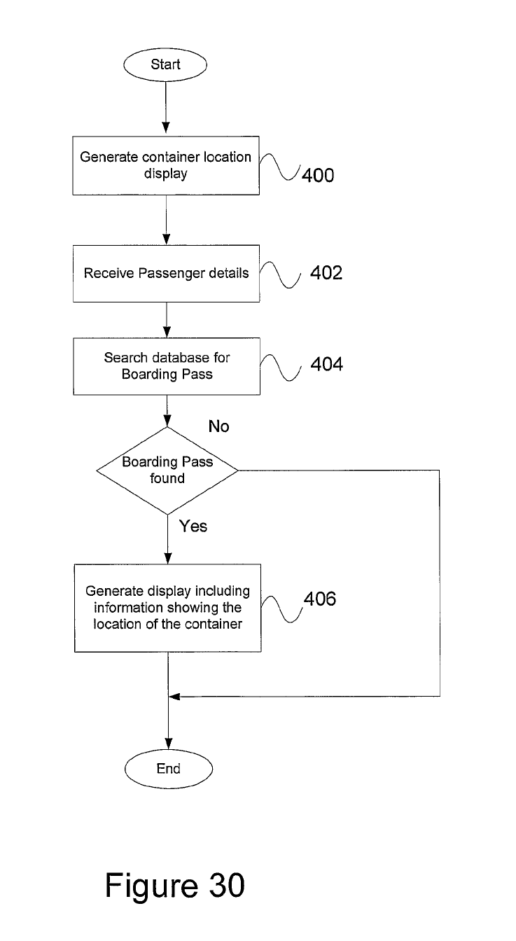

The system 112 can be used to determine the location of a passenger's container 14 on the aeroplane 12 in the event that the passenger cancels the flight after a boarding pass has been issued and his or her baggage has been stored in the racking system 314. The system 112 performs the steps shown in FIG. 30 which are described in further detail below.

A staff member can use his or her hand held computer device 118 to access the airline's web page, via the Internet 120, to check the cell number of a passenger's container 14. The system 112 web page includes a “Locate Container” function button that, when executed, generates, at step 400, a container location user interface. The staff member can enter any one of the following details to determine the cell number:
i. Passenger's surname;
ii. Seat number;
iii. Booking number; or
iv. Identifier.

The system 112 receives, at step 402, the passenger's details and searches, at step 404, through the data base 116 for a matching boarding pass. If the system 112 identifies a matching boarding pass, then the system 112 generates, at step 406, a display showing the relevant passenger's details including the cell number 312 in the racking system 314 of the aeroplane 12. The staff member can then go straight to the relevant cell 312 in the racking system 314 to look for the passenger's container 14. The staff member can then identify the passenger's container by viewing the primary identifier labels 80 of the containers stacked in the cell 312.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

1. A baggage handling process for a transport vehicle, including the steps of: (a) generating a booking for a passenger for said transport vehicle; and
(b) issuing the passenger with a container for his or her baggage, wherein the container is of a predetermined size and shape.

2. The process claimed in claim 1, including the step of generating an identifier for the container, the identifier being associated with the passenger.

3. The process claimed in claim 2, securing the identifier to the container.

4. The process claimed in claim 2, including the steps of:
(c) receiving said container from the passenger including his or her baggage stored therein; and
(d) storing the container in the transport vehicle

5. The process claimed in claim 2, including the step of generating data representing a position inside the transport vehicle for storing the container.

6. The process claimed in claim 1, wherein the passenger's baggage is secured inside the container by a temper evident security device.

7. The process claimed in claim 1, wherein the identifier is a bar code.

8. The process claimed in claim 1, wherein the transport vehicle is an aeroplane.

9. The process claimed in claim 1, wherein the passenger's baggage includes all of his or her travel items that are not necessary to board the transport vehicle.

10. A baggage handling system for a transport vehicle, said system for performing the steps of:
(a) generating a booking for a passenger for said transport vehicle;
(b) generating an identifier for a container, the identifier being associated with the passenger;
(c) issuing the passenger with the container for his or her baggage; wherein the container is of a predetermined size and shape.

11. The system claimed in claim 10, including the step of generating an identifier for the container, the identifier being associated with the passenger.

12. The system claimed in claim 11, securing the identifier to the container.

13. The system claimed in claim 11, including the steps of:
(c) receiving said container from the passenger including his or her baggage stored therein; and
(d) storing the container in the transport vehicle

14. The system claimed in claim 1, including the step of generating data representing a position inside the transport vehicle for storing the container.

15. The system claimed in claim 10, wherein the passenger's baggage is secured inside the container by a temper evident security device.

16. The system claimed in claim 10, wherein the identifier is a bar code.

17. The system claimed in claim 1, wherein the transport vehicle is an aeroplane.

18. The system claimed in claim 10, wherein the passenger's baggage includes all of his or her travel items that are not necessary to board the transport vehicle.

19. A computer program for handling baggage for a transport vehicle, said program for performing the steps of:
(a) generating a booking for a passenger for said transport vehicle;
(b) generating an identifier for a container, the identifier being associated with the passenger;
(c) issuing the passenger with the container for his or her baggage; wherein the container is of a predetermined size and shape.

20. The program claimed in claim 19, including the step of generating an identifier for the container, the identifier being associated with the passenger.

21. The program claimed in claim 20, securing the identifier to the container.

22. The program claimed in claim 20, including the steps of:
(c) receiving said container from the passenger including his or her baggage stored therein; and
(d) storing the container in the transport vehicle.

23. The program claimed in claim 20, including the step of generating data representing a position inside the transport vehicle for storing the container.

24. The program claimed in claim 20, wherein the passenger's baggage is secured inside the container by a temper evident security device.

25. The program claimed in claim 20, wherein the identifier is a bar code.

26. The program claimed in claim 20, wherein the transport vehicle is an aeroplane.

27. The program claimed in claim 20, wherein the passenger's baggage includes all of his or her travel items that are not necessary to board the transport vehicle.

28. A computer readable data storage medium, including stored thereon, the computer program claimed in claim 19.

29.-44. (canceled)
